(19) United States
(12) Patent Application Publication
(10) Pub. No.: US 2024/0425431 A1
(43) Pub. Date: Dec. 26, 2024

(54) METHOD OF FORMING A GAS GENERANT

(71) Applicant: Joyson Safety Systems Acquisition LLC, Auburn Hills, MI (US)

(72) Inventors: Sudhakar Ganta, Troy, MI (US); Deborah Hordos, Troy, MI (US)

(21) Appl. No.: 18/751,762

(22) Filed: Jun. 24, 2024

Related U.S. Application Data
(60) Provisional application No. 63/509,960, filed on Jun. 23, 2023.

(51) Int. Cl. C06B 31/00; B60R 21/264; C06B 21/00

(52) U.S. Cl. CPC C06B 31/00; B60R 21/2644; C06B 21/0008

(57) ABSTRACT

A method of forming a gas generant according to various implementations includes the steps of providing a mixture of copper nitrate and water and adding melamine and guanidine carbonate to the copper nitrate and water mixture at room temperature. Next, the melamine, guanidine carbonate, copper nitrate, and water mixture is mixed and heated to form a melamine nitrate, guanidine nitrate, basic copper nitrate, and water mixture. The heating and mixing step may be performed at a temperature in the range of 50° C. to 60° C. for at least 20 minutes. Then, the melamine nitrate, guanidine nitrate, basic copper nitrate, and water mixture is dried to form the gas generant comprising melamine nitrate, guanidine nitrate, and basic copper nitrate. The method may further comprise a step of adding an additional fuel, an additional oxidizer, or an additive. Also disclosed is a gas generant made by the method described above.

### CROSS-REFERENCE TO RELATED APPLICATION

This application claims the benefit of U.S. Provisional Application 63/509,960, filed Jun. 23, 2023, the contents of which are hereby incorporated in its entirety.

### TECHNICAL FIELD

The present disclosure relates to safety devices for passenger vehicles. In particular, the disclosure relates to a method of forming a gas generant for use in airbag gas generators. Passenger vehicles may include, for example, automobiles, boats, trains, aircrafts, and spacecrafts.

### BACKGROUND

Airbag systems have been widely adopted for improving the safety of passengers in vehicles, such as automobiles. In these systems, a gas generator is operated by ignition signals from a crash sensor detecting a collision and inflates an airbag between a passenger and a portion of the automobile. The gas generator is required to produce a sufficient amount of gas to inflate the airbag in a very short time. Typical gas generants used to generate gas in current gas generators contain, at least, an oxidizer and a fuel. The methods used to produce any particular gas generant can greatly affect the physical properties (e.g., ignition rate, burn rate, heat, sensitivity, etc.), cost, and suitability of the gas generant for inflating any particular airbag.

One example of a gas generant for use in airbags can be found in U.S. Pat. No. 10,358,393 granted to the applicant of the present application. Example fuels for use in such gas generants include melamine nitrate and guanidine nitrate, and an example oxidizer includes basic copper nitrate. Melamine nitrate and guanidine nitrate can be mixed with basic copper nitrate, with optional additives, to form the gas generant. However, each fuel and oxidizer is typically manufactured separately before being added to a gas generant mixture, leading to higher cost and complexity. For example, shipping, handling, and manufacturing fuels and oxidizers can be expensive and require an extra degree of care. Therefore, an improved process for producing a gas generant in situ would be cost efficient and safer in many respects.

### SUMMARY

Various implementations include a method of forming a gas generant. The method comprises the steps of (a) providing a mixture comprising copper nitrate and water; (b) adding melamine and guanidine carbonate to the mixture comprising copper nitrate and water at room temperature; (c) heating and mixing the melamine, guanidine carbonate, copper nitrate, and water mixture to form a melamine nitrate, guanidine nitrate, basic copper nitrate, and water mixture; and (d) drying the melamine nitrate, guanidine nitrate, basic copper nitrate, and water mixture from step (c) to form the gas generant comprising melamine nitrate, guanidine nitrate, and basic copper nitrate. The heating and mixing of step (c) is performed at a temperature in the range of 50° C. to 60° C. for at least 20 minutes and the drying in step (d) is performed at a temperature in the range of 100° C. to 110° C. for at least 4 hours. In some implementations, the method further comprises the step of adding an additional fuel, an additional oxidizer, or an additive to the gas generant. In some implementations, the method further comprises the step of pressing the gas generant into tablets or wafers.

In other implementations, a gas generant is formed by a method comprising the steps of (a) providing a mixture comprising copper nitrate and water; (b) adding melamine and guanidine carbonate to the mixture comprising copper nitrate and water at room temperature; (c) heating and mixing the melamine, guanidine carbonate, copper nitrate, and water mixture to form a melamine nitrate, guanidine nitrate, basic copper nitrate, and water mixture; and (d) drying the melamine nitrate, guanidine nitrate, basic copper nitrate, and water mixture from step (c) to form the gas generant comprising melamine nitrate, guanidine nitrate, and basic copper nitrate. The heating and mixing of step (c) is performed at a temperature in the range of 50° C. to 60° C. for at least 20 minutes and the drying in step (d) is performed at a temperature in the range of 100° C. to 110° C. for at least 4 hours. In some implementations, the method further comprises the step of adding an additional fuel, an additional oxidizer, or an additive to the gas generant. In some implementations, the method further comprises the step of pressing the gas generant into tablets or wafers. In some implementations, a gas generator comprises a gas generant formed by the method disclosed above.

### BRIEF DESCRIPTION OF THE DRAWINGS

The drawings are merely exemplary to illustrate steps, structure, and certain features that can be used singularly or in combination with other features. The disclosure should not be limited to the implementations shown.

FIG. 1 is a cross-sectional view of an airbag gas generator for use with a gas generant formed by the methods disclosed herein.

FIG. 2 is a block diagram of method steps for forming a gas generant according to one implementation.

FIG. 3 is a block diagram of method steps for forming a gas generant according to another implementation.

FIG. 4 is an FTIR plot of a comparative gas generant and a gas generant formed by the method steps of FIG. 2.

### DETAILED DESCRIPTION

### Gas Generators

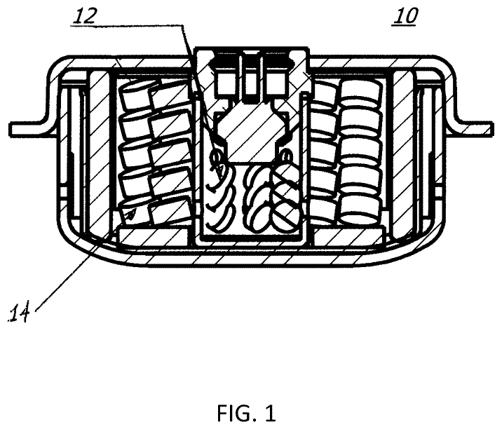

As shown in FIG. 1, an exemplary gas generator 10 comprises a single ignition chamber comprising a main gas generant 14. The gas generator 10 also comprises a booster chamber comprising a booster gas generant 12. When the gas generator 10 is deployed, booster gas generant 12 is ignited and thus causes ignition of the main gas generant 14, therefore providing inflation gas to a connected airbag (not shown). The gas generants described herein may be used for either the booster gas generant 12 or the main gas generant 14, or both. Preferably, the gas generants described herein are used for the main gas generant 14.

### Gas Generants

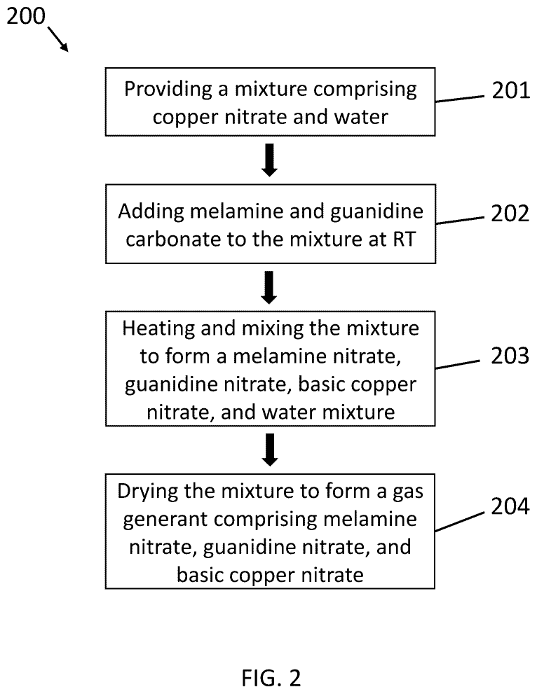

According to one implementation, a method 200 of forming a gas generant is shown in FIG. 2. In a first step 201, a mixture comprising copper nitrate and water is provided. In step 202, melamine and guanidine carbonate are added to the mixture comprising copper nitrate and water at room temperature. As used herein, room temperature is used to describe temperatures in the range of 15° C. to 25° C. At step 203, the melamine, guanidine carbonate, copper nitrate, and water mixture is mixed and heated to form a melamine nitrate, guanidine nitrate, basic copper nitrate, and water mixture. The mixing is performed for at least 10 minutes at a temperature in the range of 50° C. to 60° C., or more preferably for at least 20 minutes at a temperature in the range of 50° C. to 60° C. At step 204, the melamine nitrate, guanidine nitrate, basic copper nitrate, and water mixture from step 203 is dried to form the gas generant comprising melamine nitrate, guanidine nitrate, and basic copper nitrate. The drying in step 204 is performed for at least 2 hours at a temperature in the range of 100° C. to 110° C., or more preferably for at least 4 hours at a temperature in the range of 100° C. to 110° C. In other implementations, disclosed is a gas generant made by the method 200. In other implementations, steps 201 and 202 may be reversed, wherein a mixture comprising melamine, guanidine carbonate, and water is provided and then copper nitrate is added to the mixture comprising melamine, guanidine carbonate, and water.

The heating and mixing in step 203 may be performed using any appropriate laboratory or manufacturing equipment as determined by a person having ordinary skill in the art, so that the mixture is elevated from room temperature to within the preferred temperature range during the preferred time. Such equipment includes, but is not limited to, a laboratory hot plate with magnetic mixing bar, a production scale jacketed mixing bowl with a mounted, motorized mixer, or a production scale spray drying system. The drying in step 204 may similarly be performed using any appropriate laboratory or manufacturing equipment. Such equipment includes, but is not limited to, a temperature-controlled oven set within the preferred temperature range, a fluidized bed, or a tumble dryer.

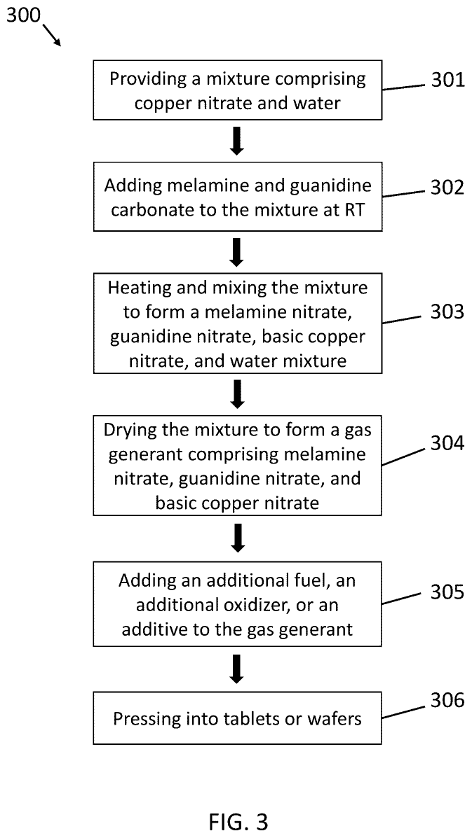

According to another implementation, a method 300 of forming a gas generant is shown in FIG. 3. Steps 301-304 are the same as steps 201-204 of method 200, however two optional, additional steps may be added. At step 305, an additional fuel, an additional oxidizer, or an additive (each discussed below) may be added to the gas generant. Regardless of whether step 305 in included or not, the gas generant at this point is typically in the form of a powder mixture. Therefore, at step 306, the gas generant in powder form may be compressed into tablet or wafer form, as required by the needs of the gas generator 10, for example. Compressing the gas generant powder into tablet or wafer form can be performed using traditional tableting presses common to the gas generator industry (similar to pharmaceutical tableting presses), as well known by those skilled in the art. In other implementations, disclosed is a gas generant made by the method 300.

During steps 203/303, chemical reactions take place that convert melamine to melamine nitrate, guanidine carbonate to guanidine nitrate, and copper nitrate to basic copper nitrate. By forming the final gas generant in situ all at once, the gas generant can be produced in a less expensive and safer manner. For example, melamine, guanidine carbonate, and copper nitrate are less expensive and safer to ship from one location to another, and they are safer for process operators to handle when compared to melamine nitrate, guanidine nitrate, and basic copper nitrate. By way of nonlimiting example, the reactions may be represented by the chemical equation below (carbon dioxide off-gas product not shown):

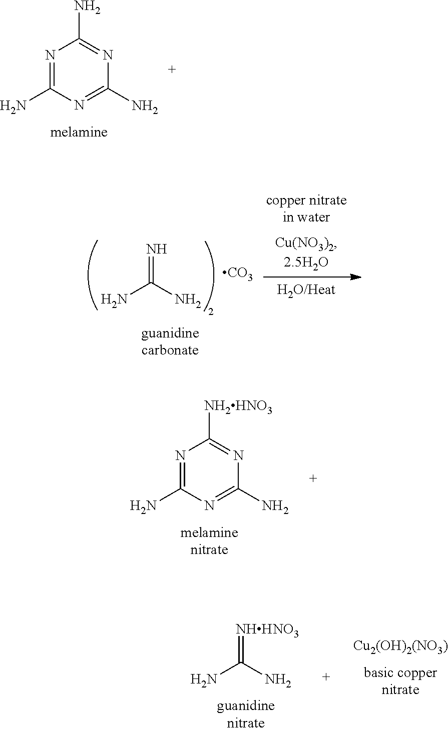

### Additional Fuels, Additional Oxidizers, and Additives

In some implementations of the gas generants and methods disclosed above, the additional fuel is selected from the group consisting of triazines and salts of triazines, tetrazoles and salts of tetrazoles, guanidines and salts of guanidines, and combinations thereof. The additional oxidizer is selected from the group consisting of metal perchlorates, nonmetal perchlorates, metal nitrates, basic metal nitrates, nonmetal nitrates, and combinations thereof. In some implementations, the additional oxidizer is a combination of ammonium perchlorate and potassium perchlorate. Additives can be included in the gas generant for a variety of purposes, such as: cooler combustion gas temperature, slagging, binding, burn-rate modification, anti-caking, and improved processing through lubrication. In some implementations, the gas generants can include a slagging agent and a lubricant.

Slagging agents help to encourage solids formation during and after combustion of the gas generant. Most gas generants will produce some solid particulate matter during combustion, and it can be important to enhance the solids formation process in order to make it easier to filter unwanted solids such that they remain within the gas generator after deployment. Slagging agents ensure the gas generants produce molten material that can act as a binding site for other materials that are close to their liquid/vapor transition points in the combustion gas. Contact with this molten material will cause certain of these materials to cool and solidify, forming larger solid clumps that can be more easily filtered by the structure of the gas generator. In some implementations, the gas generants can include one or more slagging agents which are selected from the group consisting of silicon dioxide, aluminum oxide, titanium dioxide, and combinations thereof. In some implementations, the additive includes aluminum oxide and titanium dioxide as the slagging agent.

Lubricants provide for improved flow of the gas generant powder on the tableting press, as discussed above with respect to step 306, thus leading to improved manufacturing rates and lower cost. In some implementations, the gas generants can include one or more lubricants which are selected from the group consisting of calcium stearate, magnesium stearate, molybdenum disulfide, boron nitride, stearic acid, polyethylene, paraffin, and combinations thereof. In some implementations, the additive includes polyethylene as the lubricant.

### Examples

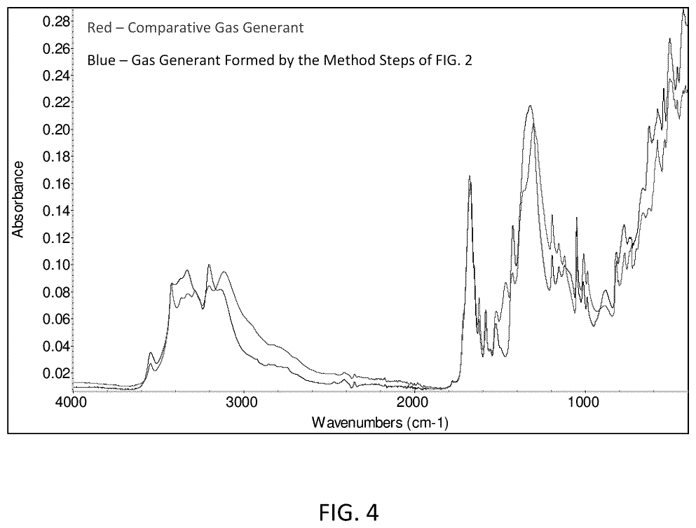

Example 1: A gas generant was prepared according to method 200, disclosed herein with respect to FIG. 2, with a>90% yield by mass. Afterwards, the gas generant was analyzed using an FTIR instrument and compared to a comparative gas generant which was also analyzed using the FTIR instrument. The comparative gas generant was created by mixing separately produced melamine nitrate, guanidine nitrate, and basic copper nitrate in water and then drying the mixture overnight. As is shown in FIG. 4, the FTIR absorbance profile of the gas generant prepared according to method 200 indicated the formation of melamine nitrate, guanidine nitrate, and basic copper nitrate, confirming the viability of method 200 to produce a high-quality gas generant in situ.

A number of implementations have been described. The description in the present disclosure has been presented for purposes of illustration but is not intended to be exhaustive of, or limited to, the implementations disclosed. It will be understood that various modifications and variations will be apparent to those of ordinary skill in the art and may be made without departing from the spirit and scope of the claims. Accordingly, other implementations are within the scope of the following claims. The implementations described were chosen in order to best explain the principles of the methods and gas generants disclosed herein and their practical application, and to enable others of ordinary skill in the art to understand the methods and gas generants and how they may be used for various implementations with various modifications as are suited to any contemplated use. The terminology used herein is for the purpose of describing particular implementations only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated steps, features, operations, elements, and/or components, but do not preclude the presence or addition of one or more other steps, features, operations, elements, components, and/or groups thereof. Any reference to a range of values specifically includes the stated values as end points within the range.

What is claimed is:

1. A method of forming a gas generant comprising the steps of:
(a) providing a mixture comprising copper nitrate and water;
(b) adding melamine and guanidine carbonate to the mixture comprising copper nitrate and water at room temperature;
(c) heating and mixing the melamine, guanidine carbonate, copper nitrate, and water mixture to form a melamine nitrate, guanidine nitrate, basic copper nitrate, and water mixture; and
(d) drying the melamine nitrate, guanidine nitrate, basic copper nitrate, and water mixture from step (c) to form the gas generant comprising melamine nitrate, guanidine nitrate, and basic copper nitrate.

2. The method of claim 1, wherein the heating and mixing of step (c) is performed at a temperature in the range of 50° C. to 60° C. for at least 20 minutes.

3. The method of claim 1, wherein the drying of step (d) is performed at a temperature in the range of 100° C. to 110° C.

4. The method of claim 3, wherein the drying of step (d) is performed for at least 4 hours.

5. The method of claim 1, further comprising the step of adding to the gas generant an additional fuel, an additional oxidizer, an additive, or a combination thereof.

6. The method of claim 5, wherein the additional fuel is selected from the group consisting of triazine, salts of triazines, tetrazole, salts of tetrazoles, guanidine, salts of guanidines, and combinations thereof.

7. The method of claim 5, wherein the additional oxidizer is selected from the group consisting of metal perchlorates, nonmetal perchlorates, metal nitrates, basic metal nitrates, nonmetal nitrates, and combinations thereof.

8. The method of claim 5, wherein the additive comprises silicon dioxide, aluminum oxide, titanium dioxide, calcium stearate, magnesium stearate, molybdenum disulfide, boron nitride, stearic acid, polyethylene, paraffin, or a combination thereof.

9. The method of claim 1, further comprising the step of pressing the gas generant into tablets or wafers.

10. An airbag comprising a gas generator comprising the tablets or wafers of claim 9.

11. A gas generant made by the method comprising the steps of:
(a) providing a mixture comprising copper nitrate and water;
(b) adding melamine and guanidine carbonate to the mixture comprising copper nitrate and water at room temperature;
(c) heating and mixing the melamine, guanidine carbonate, copper nitrate, and water mixture to form a melamine nitrate, guanidine nitrate, basic copper nitrate, and water mixture; and
(d) drying the melamine nitrate, guanidine nitrate, basic copper nitrate, and water mixture from step (c) to form the gas generant comprising melamine nitrate, guanidine nitrate, and basic copper nitrate.

12. The gas generant of claim 11, wherein the heating and mixing of step (c) is performed at a temperature in the range of 50° C. to 60° C. for at least 20 minutes.

13. The gas generant of claim 11, wherein the drying of step (d) is performed at a temperature in the range of 100° C. to 110° C.

14. The gas generant of claim 13, wherein the drying of step (d) is performed for at least 4 hours.

15. The gas generant of claim 11, further comprising the step of adding to the gas generant an additional fuel, an additional oxidizer, an additive, or a combination thereof.

16. The gas generant of claim 15, wherein the additional fuel is selected from the group consisting of triazine and salts of triazines, tetrazole and salts of tetrazoles, guanidine and salts of guanidines, and combinations thereof.

17. The gas generant of claim 15, wherein the additional oxidizer is selected from the group consisting of metal perchlorates, nonmetal perchlorates, metal nitrates, basic metal nitrates, nonmetal nitrates, and combinations thereof.

18. The gas generant of claim 15, wherein the additive comprises silicon dioxide, aluminum oxide, titanium dioxide, calcium stearate, magnesium stearate, molybdenum disulfide, boron nitride, stearic acid, polyethylene, paraffin, or a combination thereof.

19. The gas generant of claim 11, wherein the method further comprises the step of pressing the gas generant into tablets or wafers.

20. An airbag comprising a gas generator comprising the tablets or wafers of claim 19.
